(19) United States
(12) Patent Application Publication
(10) Pub. No.: US 2017/0364333 A1
(43) Pub. Date: Dec. 21, 2017

(54) SYSTEM FOR AUTOMATED CODE CALCULATION AND AN AUTOMATED CODE CALCULATION METHOD

(71) Applicant: Austin Consultants Limited, Bath (GB)

(72) Inventors: Peter Davies, London (GB); Bo Fu, London (GB)

(73) Assignee: Austin Consultants Limited, Bath (GB)

(21) Appl. No.: 15/628,054

(22) Filed: Jun. 20, 2017

(30) Foreign Application Priority Data
Jun. 20, 2016 (GB) 1610753.4

(51) Int. Cl. G06F 9/44; G06F 17/27

(52) U.S. Cl. CPC G06F 8/30; G06F 8/33; G06F 17/276

(57) ABSTRACT

A method of configuring an automated code calculation system, comprising retrieving information relating to a group of two or more functions, updating a weighting value for each combination of an item from a first set and an item from a second set, where each item in the first set and each item in the second set corresponds to one or more functions, where the weighting value is higher if the items are both contained in the group of functions than if one of the items is not contained in the group of functions and storing the weighting values together with the corresponding combination of items.

### CROSS-REFERENCE TO RELATED APPLICATIONS

This application is based upon and claims the benefit of priority from prior United Kingdom Application number 1610753.4 filed on Jun. 20, 2016, the entire contents of which are incorporated herein by reference.

### FIELD OF THE INVENTION

The present invention relates to a system for automated code calculation and an automated code calculation method.

### BACKGROUND OF THE INVENTION

There is a continuing need to produce more efficient, less error prone computer code for various applications, i.e. code that results in the computer performing the task with less computational resources.

Integrated Development Environments can provide function name auto-completion to the user. Also, the LabVIEW™ environment allows the user to select functions by clicking various icons. However, these systems require the user to either type in the first half of the function or navigate to the function icon from a fixed number of icons. Thus the user still initiates the choice of the function, and the resulting code may therefore still be inefficient and prone to error.

### BRIEF DESCRIPTION OF THE DRAWINGS

Systems and methods in accordance with non-limiting embodiments will now be described with reference to the accompanying figures in which:

FIG. 1 is a schematic illustration of an automated code calculation system in accordance with an embodiment of the invention;

FIG. 2 is a flow diagram of a method of configuring an automated code calculation system in accordance with an embodiment of the invention;

FIG. 3 is a flow diagram of a method of automated code calculation in accordance with an embodiment of the invention;

FIG. 4 is a flow diagram of a method of configuring an automated code calculation system in accordance with an embodiment of the invention;

FIG. 5 is a flow diagram of a method of automated code calculation in accordance with an embodiment of the invention;

FIG. 6 shows the setup of a system comprising the automated code calculation system according to an embodiment of the invention;

FIG. 7 shows a flow diagram of a method of automated code calculation in accordance with an embodiment of the invention;

FIG. 8 shows a flow diagram of a method of automated code calculation in accordance with an embodiment of the invention;

FIG. 9 shows a flow diagram of a method of automated code calculation in accordance with an embodiment of the invention;

FIG. 10 shows a flow diagram of a method of automated code calculation in accordance with an embodiment of the invention.

### DETAILED DESCRIPTION OF THE PREFERRED EMBODIMENTS

According to an embodiment, there is provided a method of configuring an automated code calculation system, comprising retrieving information relating to a group of two or more functions, updating a weighting value for each combination of an item from a first set and an item from a second set, wherein each item in the first set and each item in the second set corresponds to one or more functions, wherein the weighting value is higher if the items are both contained in the group of functions than if one of the items is not contained in the group of functions and storing the weighting values together with the corresponding combination of items.

In an embodiment, the information relating to the group of functions comprises the order of the functions in the group, wherein the weighting value is higher if the item from the second set is the next item in the group after the item from the first set, than if it is not the next item in the group.

In an embodiment, the information relating to the group of functions comprises information relating to the creation time of the group of functions, wherein if the items are both contained in the group of functions, the weighting value is updated by a larger amount for a first group than for a second group where the creation time for the first group is more recent than for the second group.

In an embodiment, the weighting value is higher if the creation time is within a fixed time period.

In an embodiment, the group of functions is a node-based code.

In another embodiment, there is provided a method of automated code calculation, comprising retrieving information relating to one or more functions, searching for an item from a stored first set corresponding to the one or more functions, wherein each item in the first set corresponds to one or more functions and outputting a list of the one or more items from a stored second set with a highest weighting value corresponding to the item from the first set, wherein each item in the second set corresponds to one or more functions.

In an embodiment, if the user selects an item from the second set, the weighting value for the combination of items corresponding to the item from the first set and the selected item from the second set is updated to a higher value.

In an embodiment, if the user selects an item which is not in the second set, the item is added to the second set a weighting value is allocated.

In an embodiment, the method further comprises obtaining information identifying an item corresponding to one or more functions and adding the item to the first set or the second set.

In an embodiment, the method further comprises retrieving information relating to a plurality of groups of functions, converting each group to a multi-dimensional vector, wherein each dimension corresponds to a function and storing the vectors.

In an embodiment, converting a group to a vector comprises searching the information for a function corresponding to each function in a third set, wherein each function in the third set corresponds to a dimension and updating a counting value corresponding to each dimension, wherein the counting value is higher if the function is contained in the group of functions than if the function is not contained in the group of functions.

In an embodiment, the counting value is updated each time the corresponding function is found in the group, such that that counting value is higher the more times the function is contained in the group.

According to another embodiment, there is provided a method of automated code calculation, comprising retrieving information relating to a group of one or more functions, converting the group to a multi-dimensional vector, wherein each dimension corresponds to a function, storing the vector, determining a difference measure between the vector and each stored vector and outputting a list of one of more groups of functions and/or information of the location of code of one or more functions of the groups of functions corresponding to the one or more vectors with the lowest difference measure.

In an embodiment, converting the item to a vector comprises searching the information for a function corresponding to each function in a third set, wherein each function in the third set corresponds to a dimension and updating a counting value corresponding to each dimension, wherein the counting value is higher if the function is contained in the group of functions than if the function is not contained in the group of functions.

In an embodiment, the counting value is updated each time the corresponding function is found in the group, such that that counting value is higher the more times the function is contained in the group.

In an embodiment, the difference measure is a distance measure or a cosine similarity.

According to another embodiment, there is provided a system for automated code calculation, the system comprising an input for receiving information relating to groups of one or more functions, an output for outputting code information and a processor, The processor is configured to update a weighting value for each combination of an item from a first set and an item from a second set, wherein each item in the first set and each item in the second set corresponds to one or more functions, wherein the weighting value is higher if the items are both contained in the group of functions than if one of the items is not contained in the group of functions store the updated weighting values together with the corresponding combination of items, search for an item from the first set corresponding to a group and output a list of the one or more items from the second set with the highest weighting value corresponding to the item from the first set, wherein each item in the second set corresponds to one or more functions.

According to another embodiment, there is provided a system for automated code calculation. The system comprises an input for receiving information relating to groups of one or more functions, an output for outputting code information and a processor. The processor is configured to convert a group to a multi-dimensional vector, wherein each dimension corresponds to a function, store the vector, determine a difference measure between the vector and the stored vectors and output a list of one of more groups of functions corresponding to the one or more vectors with the lowest difference measure.

In an embodiment, the processor is further configured to perform tasks relating to control of an apparatus, wherein the system further comprises an apparatus output for outputting control signals to an apparatus.

In an embodiment, there is provided an apparatus controlled by a system as described above.

In an embodiment, there is provided a carrier medium comprising computer readable code configured to cause a computer to perform a method as described above.

In an embodiment, there is provided a method of automated code calculation and implementation for a data flow programming language.

The retrieved information relating to a group of two or more functions may be information relating to pre-existing code. The information may comprise a list of the function names used in the code for example. The pre-existing codes may be codes previously written by the user, or another individual, or a specific group of individuals. The pre-existing codes may be codes previously written for a specific application. The pre-existing codes may originate from an online code resource for example.

The pre-existing codes may be codes that have been previously tested and refined. The codes are thus more efficient and less error prone. Basing code suggested by the automated code calculation system on such previous code means that the code produced by such a system is also more efficient and less error prone, allowing the computer to run the code with less computational resources used.

In this specification, the term “function” refers to a unit of code. The code may be in any data flow programming language, or a text based language for example. For example, a function may be ‘Read from Text File’ in the graphical language G used in the LabVIEW™ environment. It is emphasised, however, that the present invention is not limited to LabVIEW™ and may apply to other node based programming languages or environments, such as Agilent VEE, Simulink or VHDL, to name a few, or text based languages.

Although the overall code produced by a user may vary from application to application, the group of functions in a code or a section of the code can be very similar. In the automated code calculation system, correlation between functions is learned from the code history, and an algorithm is used to provide a list of suggested functions to a user when the user inputs a new function. Suggesting multiple functions, each of which are correlated to the new function, to the user while the user is programming can save the user time whilst ensuring that previously learnt reliable programming practices are used by the programmer or are at least prominently suggested for use.

The code calculation system may compute the correlation between functions from pre-existing code and store the correlation, for example into a database. The correlation may be the probability of a particular combination of functions being contained in a code for example. When the user is programming, the system detects which functions are inputted by the user and selects the most likely next multiple functions from the database. The algorithm may rank the suggested functions based on the correlations. After the user selects or enters a function, the system updates the correlations stored in the database.

The correlations may be determined using an N-grams method with orders, local correlation, or vectorisation for example.

Since some methods in accordance with embodiments can be implemented by software, some embodiments encompass computer code provided to a general purpose computer on any suitable carrier medium. The carrier medium can comprise any storage medium such as a floppy disk, a CD ROM, a magnetic device or a programmable memory device, or any transient medium such as any signal e.g. an electrical, optical or microwave signal. The carrier medium may comprise a non-transitory computer readable storage medium.

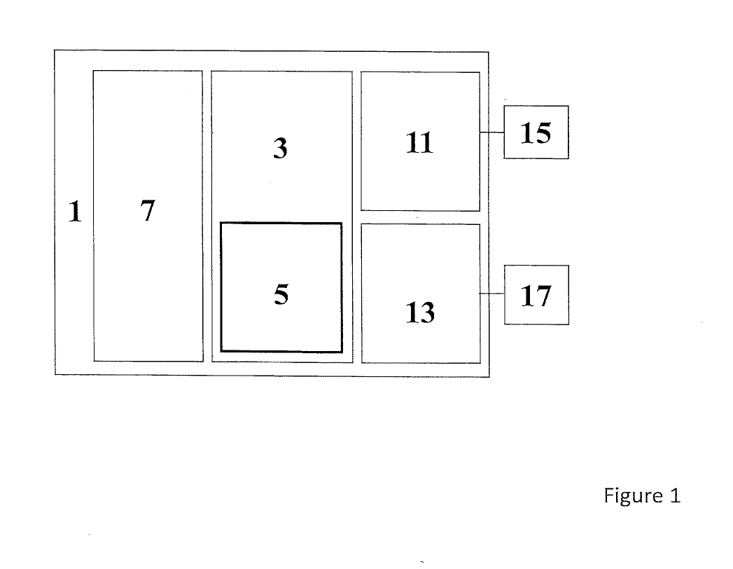

In an embodiment, the computer code is suitable for controlling an apparatus, for example a laboratory apparatus, and the functions relate to tasks which control such apparatus. FIG. 1 is a schematic illustration of an automated code calculation system 1 in accordance with an embodiment.

The system 1 comprises a processor 3 which takes input code and outputs suggested code. A computer program 5 is stored in non-volatile memory. The non-volatile memory is accessed by the processor and the stored code is retrieved and executed by the processor 3. The storage 7 stores data that is used by the program 5.

The system 1 further comprises an input module 11 and an output module 13. The input module 11 is connected to an input 15 for receiving data relating to the code. The input 15 may be an interface that allows a user to directly input data, for example a keyboard. Alternatively, the input may be a receiver for receiving data from an external storage medium or a network.

Connected to the output module 13 is output 17. The output 17 may be an interface that displays data to the user, for example a screen. Alternatively, the output may be a transmitter for transmitting data to an external storage medium or a network.

In use, the system 1 receives data through data input 15. The program 5, executed on processor 3, outputs suggested code in the manner which will be described with reference to the following figures. The system may be configured in the manner which will be described with reference to the following figures.

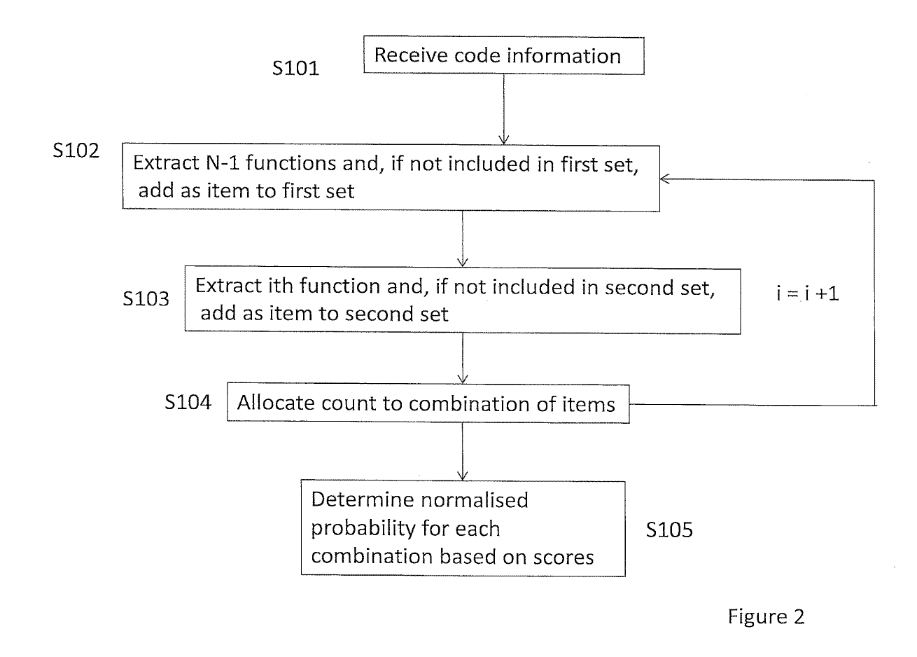

FIG. 2 is a flow diagram of a method of configuring an automated code calculation system in accordance with an embodiment. The method may be based on an n n-grams algorithm.

In step S101, information relating to one or more pre-existing software codes is retrieved. When referring to retrieving, any manner in which the code may be entered into, received at or retrieved by the system is being referred to. Although the term code is used, any group of two or more functions can be retrieved and processed. Retrieving the information may comprise retrieving a file storing the information from local or external storage. For example, a file comprising information relating to one or more codes previously written by the user or relating to codes originating from an online code resource may be retrieved by the system. The file may comprise a list of the function names used in the code. The function names may be listed in the order in which they were executed in the code for example, or in the order in which they were listed in the code. Alternatively, the file may be a file relating to a code which is being currently written by the user, where the information in the file is being continuously updated as the user enters the code. To enable use of code that is currently being written by the user such code may be stored in a database to make it available for use in the embodiment.

In an embodiment, the codes are suitable for the LabVIEW™ environment. LabVIEW™ codes may be used to control apparatus to perform, for example, data acquisition, instrument control, and industrial automation. Functions in LabVIEW™ are referred to as nodes (built-in functions) or SubVIs (custom-made functions), and each node or SubVI has an associated label name which identifies the node, for example ‘Add’, ‘Open/Create/Replace File’ and ‘DAQmx Timing.vi’ etc.

For codes written in the LabVIEW™ environment, the label name of each node in the LabVIEW™ code may be extracted, for example using a function such as “Traverse for GObject.vi” which extracts the properties of each node, and the list of label names may then be written to a file for example.

The pre-existing code may be a collection of codes written by an individual or group of individuals for example, the example codes provided by NI LabVIEW™, or written for a particular application, for example, the code to acquire voltage signals and save the signals to files.

A representation of the information in the file for each code is shown in Table 1 below. Each file comprises information relating to a group of functions, in this case each file relates to a code. The functions names are represented by letters A to H in this example. Each function could be, for example, Build Path, Open/Create/Replace File, Write to Text File, Read from Text File and Close File.

TABLE 1
Representation of information contained in each file

| Code | Sequence of functions |
|---|---|
| 1 | A, B, C, D, E, F |
| 2 | A, B, D, C, G, H |
| 3 | A, B, C, D, G, H |
| 4 | A, B, C, D, E, G, H |
| 5 | A, B, C, D, E, F, G |

Each file thus comprises a list of function names, which identify the corresponding function.

In the following steps, one or more functions are extracted from the file in turn and stored as a list, for example, they may be stored as row headings in a database. The extracted function(s) is referred to as an “item” and the stored list containing the items is referred to as the “first set”.

A user defined value N sets the size of the items in the first set, i.e. how many functions are contained in one item in the first set, where each item in the first set is N−1 functions.

In step S102, the N−1 functions prior to the ith function are extracted from the first input file, in other words, the {i−(N−1)}th function to the {i−1}th function. i is simply an index term, and for the first iteration, i corresponds to the Nth function.

In this example, N=3 is used, and thus the first two functions of Code 1, A, B, are extracted in the first iteration. However, it will be understood that N may be any value. The N−1 functions before the ith function are extracted.

It is then determined whether a first set comprises an existing item corresponding to the extracted item. If not, the extracted item is added to the first set. For an N-grams algorithm, the first set is the (RowID), and the system extracts the (N−1) functions and sets this item as the key (Row ID) in a database.

In step S103, the ith function is extracted. In this example, where N=3, the third function, C, is extracted in the first iteration. It is then determined whether a second set comprises an existing item corresponding to the extracted item. If not, the item is added to the second set. For an n-grams method, the system records the N-th function as a (ColumnID) in the database.

In S104, a count is added to the combination of the item in the first set and the item in the second set. Thus a count is added to the entry corresponding to the (RowID) and the (ColumnId) in the database. For example, a count of +1 may be added to the existing score corresponding to the combination. Although the example count +1 is given here, it will be appreciated that any counting system may be used to differentiate between the case where the second item follows the first item in the inputted group and the case where it doesn't. For example, a higher count may be allocated to the combination where the second item follows the first item than where it doesn't.

The system then moves forward one function. The index i is set to i=i+1, the next group of (N−1) functions prior to the ith function are extracted, and the procedure repeated.

After the system has processed all of the functions in the group, it then moves on to the next group, corresponding to the next input file, and repeats the process.

Thus a table in which for each (N−1) function combination, i.e. each item in the first set, there are multiple i-th functions i.e. items in the second set, together with the scores is populated. Table 2 below shows a representative table for the example.

TABLE 2
Generated score table

| | | | | | | | | |
|---|---|---|---|---|---|---|---|---|
| Row ID | A | B | C | D | E | F | G | H |

| | | | | | | |
|---|---|---|---|---|---|---|
| A, B | 4 | 1 | | | | |
| B, C | | 4 | | | | |
| C, D | | | 3 | | 1 | |
| D, E | | | | 2 | 1 | |
| B, D | 1 | | | | | |
| D, C | | | | | 1 | |
| C, G | | | | | | 1 |
| D, G | | | | | | 1 |
| E, G | | | | | | 1 |

In S105, for each item in the first set, the scores are converted into a normalised probability corresponding to each item in the second set. The normalised probabilities are stored in the storage 7. The normalised probabilities are examples of weighting values.

Although in the example described, the items in the first set and the second set were extracted from the inputted file, it will be understood that the sets may be pre-populated with items, and the configuration process may simply comprise allocating a score to each combination.

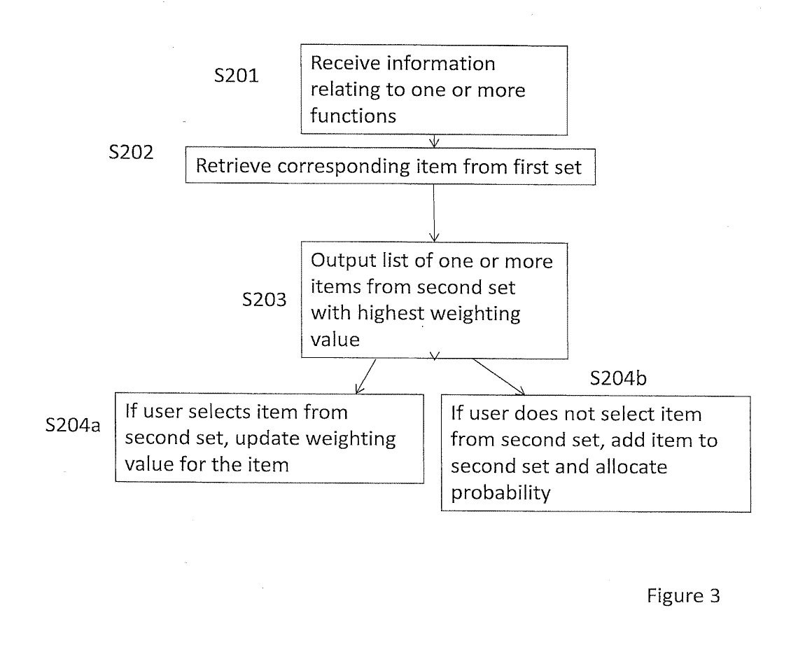

FIG. 3 is a flow diagram of a method of automated code calculation in accordance with an embodiment of the invention. When a user inputs one or more functions into a code, information relating to the functions is then retrieved. For example, a label name may be extracted corresponding to the function.

The system then extracts the N−1 most recent entry or entries in the file and determines whether there is an item from the first set corresponding to extracted entry or entries in step S202. In the example described, in which the stored items in the first set consist of two functions, the system extracts the two most recent entries, determines whether there is an item from the first set corresponding to the two entries, and if so, retrieves the item. In an embodiment, if it is determined that no item in the first set corresponds to the extracted entry or entries, the system determines whether each N−2 function combination in the extracted entries matches each N−2 function combination in the items in the first set. If it is determined that no item in the set corresponds to the extracted entry or entries, the system determines whether each N−M function combination in the extracted entries matches each N−M function combination in the items in the set, increasing M until N−M=1. If no corresponding item is found, then no suggestion is given, and the user may enter a function un-prompted.

The system then outputs a list of the one or more items from the second set with the highest weighting value corresponding to the item from the first set in step S203. For example, the system may output the three items with the highest weighting values. The list may be displayed on the screen, such that the user may select one of the items and it is automatically included in the code. The information relating to the suggested functions may be displayed in a pop-up window. The information can be the name of the function or/and the icon of the function (in LabVIEW™). The user can then either use a combined key (e.g. Ctrl and Number) or mouse dragging to select the function. The items may be ranked based on the weighting values, or alternatively provided in no particular order. The suggested functions may be ranked with probability in descending order for example.

In an embodiment, the input information comprises the creation time of the pre-existing code and the allocated counts are higher for more recently created codes. For example, the allocated count may be higher if the creation time is within a fixed time period, for example within the previous month. For example, the codes 4 and 5 have been generated in the previous month, but the codes 1, 2 and 3 generated prior to the previous month. The allocated counts for the codes 4 and 5 may then correspond to +2 for combination of items which are present, instead of +1 for example.

In an embodiment, if the user selects an item from the second set in response to the code suggestion list, the stored weighting value for the combination of items corresponding to the retrieved item from the first set and the selected item from the second set is updated to a higher value in step S204a. Where the weighting values are normalised probabilities, this involves re-evaluating all of the probabilities for the item from the first set, such that the probabilities of all of the items from the second set corresponding to the item from the first set sum to 1.

If the user selects an item that is not in the second set, the item, in one embodiment, is added to the second set and allocated a weighting value in step S204b. Again, in one embodiment this involves re-evaluating the probabilities for all of the items corresponding to the first item.

In an embodiment, the system may not be initially configured using pre-existing codes or may continue to configure as the user programs. In these embodiments, the user enters each function into a code, and a label name is extracted corresponding to the function in real time, and stored in a file, which is then retrieved by the system, as in step S101. After N functions have been entered by the user, the N−1 functions prior to the ith function are added as an item to the first set, as in S102, the ith function is extracted and added to the second set, as in S103, a score is allocated, as in S104, and a normalised probability determined as in S105. The system then extracts the N−1 most recent entry or entries and determines whether there is an item from the first set corresponding to the extracted entry or entries, as in step S202, and performs the steps of FIG. 3. As before, if it is determined that no item in the first set corresponds to the extracted entry or entries, no suggestion is given, and the user enters the next function without prompting. The system then moves on an iteration, such that i=i+1 and repeats the process. If it is determined that an item in the first set corresponds to the extracted entry or entries, the suggestions are given, and the user enters the next function either based on the suggestion or not. The stored information is updated accordingly, and the system also then moves on an iteration, such that i=i+1 and repeats the process.

In the example described, the input information comprised the order of the functions in the previous code, e.g. the file comprised the list of function names in the order in which they were executed or the order in which they were entered by the user. However, the input information relating to the pre-existing code may simply comprise a list of the function names corresponding to the functions in the code, the function names being different to the order in which the functions were executed. For example, the function names may be in a random order.

Although in the example described the system extracts the subsequent function or functions from the inputted group, all of the previous and subsequent functions may be extracted and added to the second set, and a count allocated for the combination with the item from the first set. This is a local correlation method.

In this case, the N−1 functions are included in the first set, and then each of the other functions are extracted in turn and included in the second set, and a count is allocated to each of the functions. Thus each of the functions prior to and subsequent to the N−1 functions are extracted and added to the second set, and the count indicates only that the items are in the same group, not the order. Furthermore, where each item in the first set corresponds to two or more functions, the order of the functions within the item is not considered. For example, the item “A, B” is equivalent to “B, A”, in other words the items comprise a “non-ordered” collection of one or more functions.

It will be understood that each item in the first set and the second set may comprise one or more functions, and that the items in the first set and second set may each comprise a different number of functions, for example, some of the items in the first set may comprise two functions, and some of the items may comprise only one function.

In an embodiment, instead of the user selecting the functions, the system inputs the function with the highest probability into the code, and then determines the next most probable function, and so on. In this embodiment, the system may generate an entire code based on the initial user input. The user initially inputs one or more functions into a code. The system then extracts the N−1 most recent entry or entries, as described previously, and determines whether there is an item from the first set corresponding to extracted entry or entries. The system then outputs the item from the second set with the highest weighting value corresponding to the item from the first set, and enters the corresponding function into the code. Thus for example, the user may enter function A followed by function B. The system then determines whether there is an item from the first set corresponding to A, B and outputs the item from the second set with the highest weighting value, in this case C. The system then inputs function C into the code, and then determines whether there is an item from the first set corresponding to B, C, and so. Thus in this case, the retrieved information relating to one or more functions may be information relating to one or more functions which were entered into the code by the system itself.

This system thus generates the code automatically without further input from the user, i.e. only the initial input is given by the user. The system is configured using pre-existing code as described in relation to FIG. 2 for example, such that there is stored table of normalised probabilities. After the user inputs one or more functions into a new code, the system determines the next function of the most likelihood, as described in relation to FIG. 3 and automatically adds that to the code. Then the system extracts information relating to the current functions in the code (which includes the newly input function) and determines the next function, and so on. The system continues to generate the code until it determines a function which has a finishing feature as the next function. A finishing feature may, for example, be a flag associated with functions in historical code that indicates that the flagged function is the final function of the code. It will be appreciated that other such indicators may be used.

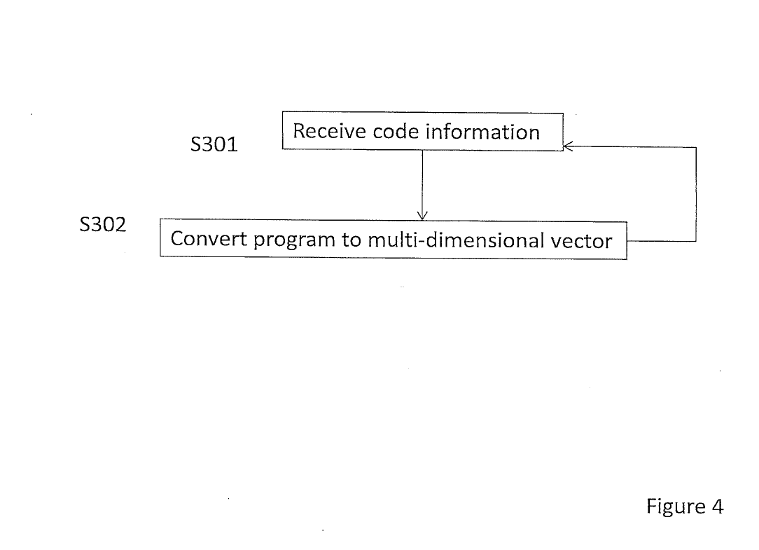

FIG. 4 is a flow diagram of a method of configuring an automated code calculation system in accordance with another embodiment of the invention.

Information is retrieved by the system relating to one or more pre-existing codes in S301. This step is the same as described in relation to FIG. 2 for example.

The information relating to each code is then converted to a multi-dimensional vector, wherein each dimension corresponds to a function.

A list of the possible functions is stored in the storage 7. For LabVIEW™, the list of possible functions may comprise 500 functions for example. The list of possible functions is referred to in this example as the third set, where each item in the third set corresponds to a possible function.

An example using the representation of the information in the file for each code shown in Table 1 above will be described. In this example, it will be considered that the possible functions are represented by letters A to H.

For each code, a count is allocated corresponding to each item of the third set when the function corresponding to the item is determined to be present. In general, any system may be used to differentiate between the case where the item is present in the code and the case where the item is not present in the code, e.g. +1 for present and 0 for not present. The set of scores corresponding to the code is the multi-dimensional vector, where each dimension corresponds to an item in the third set, i.e. a possible function. For the example, the vectors are given below:

Code 1: V₁=[1, 1, 1, 1, 1, 1, 0, 0]

Code 2: V₂=[1, 1, 1, 1, 0, 0, 1, 1]

Code 3: V₃=[1, 1, 1, 1, 0, 0, 1, 1]

Code 4: V₄=[1, 1, 1, 1, 1, 0, 1, 1]

Code 5: V₅=[1, 1, 1, 1, 1, 1, 1, 0]

A count of +1 is added to the existing score each time the function is found in the code. Thus where the function is contained twice in the code, the score will be 2.

The vectors are stored in the storage 7.

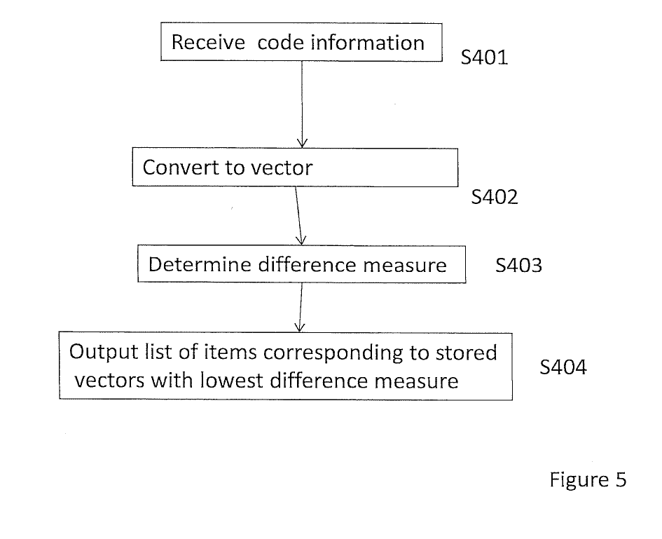

FIG. 5 is a flow diagram of a method of automated code calculation in accordance with an embodiment.

When a user enters one or more functions into a code, information relating to the one or more functions is then retrieved as described in relation to FIG. 3. For example, a label name may be extracted corresponding to the function.

The system extracts information relating to a number of the most recent functions in the code, and in step S402, converts this into a multi-dimensional vector, Vₓ, wherein each dimension corresponds to a function, in the same manner as described in relation FIG. 3. The number of functions for which information is extracted may be defined by the user for example, or may be all of the functions in the code.

A count of +1 is allocated corresponding to each item of the third set, when the function corresponding to the item is determined to be present.

In step S403, a difference measure between the input vector and each of the stored vectors is calculated. Any suitable difference measure may be used. For example, a distance measurement may be used, where, for the example given:

dₘ=\sqrt{ΔS_{A}²−ΔS_{B}²−ΔS_{C}² . . .}

where dₘ is the distance measure corresponding to the code m, and ΔS_{A} is the difference between the score allocated corresponding to the item A of the third set for the code m and the score allocated corresponding to the item A of the third set for the new input.

Alternatively, the distance measure may be a cosine similarity, where:

$${d}_{m} = \frac{{V}_{1} \cdot {V}_{x}}{‖ {V}_{1} ‖ ‖ {V}_{x} ‖}$$

Thus a list of difference measures is generated corresponding to the users entry, each difference measure corresponding to a stored vector.

In step S404, a list of one of more codes corresponding to the vectors with the lowest difference measure is outputted. For example, the three codes corresponding to the vectors with the lowest difference measures may be outputted. The items may be ranked based on the difference measure, or alternatively provided in no order. Alternatively, the link of the code with the lowest difference can be provided. As mentioned previously, the historical code considered may be located in any location accessible to the device executing the presently described method. This includes other computers linked to the device via a network. The location information including the file path and/or the internet address are stored as an extra column of each row when saving to the database, for example as shown below:

Code 1: V₁=[1, 1, 1, 1, 1, 1, 0, 0] [File path/URL 1]

Code 2: V₂=[1, 1, 1, 1, 0, 0, 1, 1] [File path/URL 2]

Code 3: V₃=[1, 1, 1, 1, 0, 0, 1, 1] [File path/URL 3]

By providing a link to the suggested code the user can check the entire suggested code before selecting it for its own use. It will be appreciated that providing links to code that has been determined as being the likely most suitable code/that has a highest probability of being selected by the user, or indeed of any code suggested to the user for selection, is envisaged as part of embodiments of the present disclosure, irrespective of how suggested code is calculated.

Again, although the example has been described in terms of “codes”, any group of two or more functions can be inputted and processed in the method of FIGS. 4 and 5. In an embodiment, where the group contains a different number of functions to one or more of the stored vectors, a number of the most similar vectors may be retrieved, and the functions common to the codes corresponding to these vectors extracted, and these common functions outputted.

In an embodiment, the inputted information comprises information relating to the creation time of the code and the allocated counts are higher for more recent codes. For example, the allocated count may be higher if the creation time is within a fixed time period, for example within the previous month. For example, the codes 4 and 5 have been generated in the previous month, but the codes 1, 2 and 3 generated prior to the previous month. The allocated counts for the codes 4 and 5 may then correspond to +2 for the items of the first set which are present, instead of +1 for example.

The method according to this embodiment is based on a vectorisation method. In this system, each function is a dimension in the multi-dimensional space and each group, i.e. code or multiple continuous functions, is converted to a vector. The trained system reflects the similarity of the groups. When the user inputs a function, the trained system searches for the similar multiple functions and proposes them to the user.

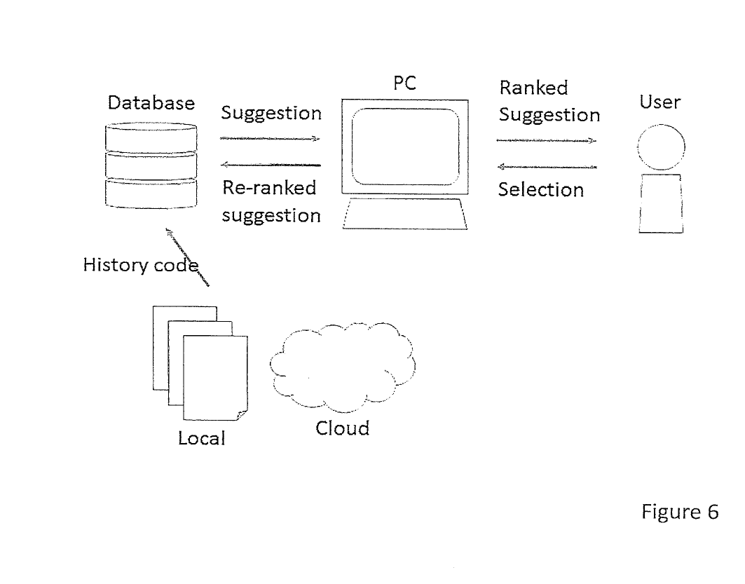

FIG. 6 shows the setup of a system comprising the automate code calculation system according to an embodiment.

The system comprises a terminal comprising an output, e.g. a screen, to present the suggested functions to the user and an input, e.g. a keyboard, to receive the user's selection, a stored database to store the probability of different functions and a history code, i.e. pre-existing code, that can be stored locally and/or remotely.

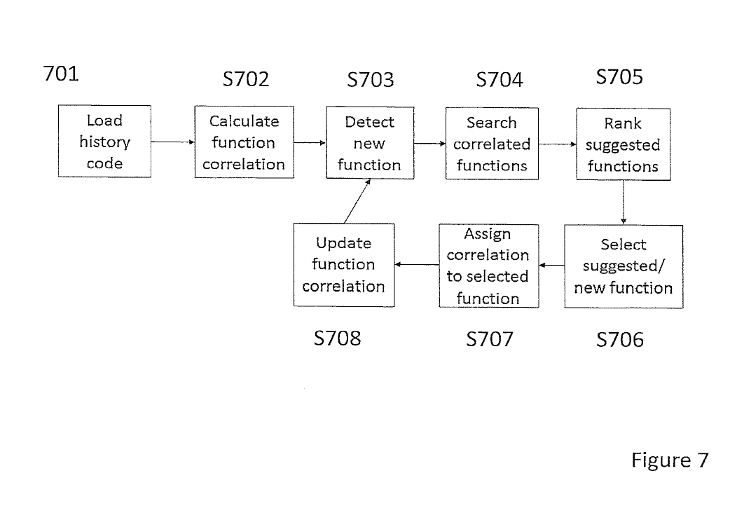

FIG. 7 shows a flow diagram of a method of automated code calculation in accordance with an embodiment.

The system pre-loads the code from the history code, i.e. pre-existing code, which can be either stored on the local machine or in an online code resource for example in step S701. It computes the probabilities of combinations of functions given the existing functions in the pre-existing code, in step S702. Then the system saves the probability information on a database.

While the user is programming, the system detects the function or functions entered by the user in S703, and searches for multiple possible next functions with the highest probabilities in step S704. The suggested functions may be ranked in S705.

The user then either selects a function suggested by the system or uses a new function in S706. In the first case the system assigns a higher probability to the selected function and updates the database, in the latter case the system adds the function to the database and gives the new function a probability, in S707 and S708.

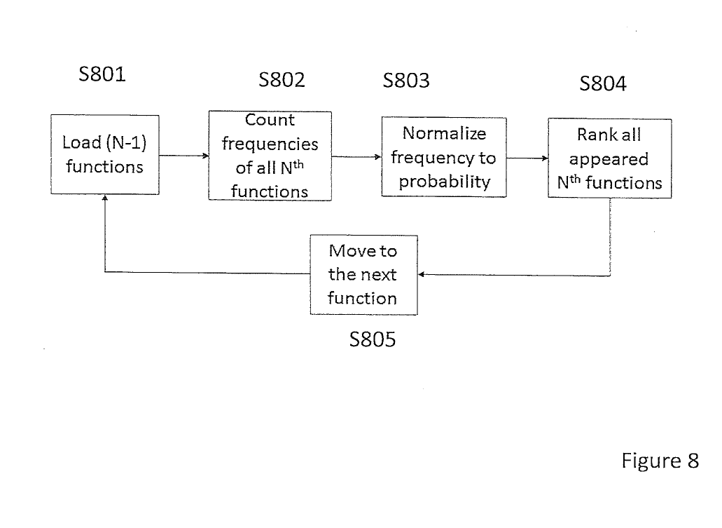

FIG. 8 shows a flow diagram of a method of automated code calculation in accordance with an embodiment. The method is based on an n-grams method.

For each input file, the system reads the functions from the beginning. For an N-grams algorithm, the system reads (N−1) functions in S801 and sets this group of functions as the key (Row ID) in the database. Then the system records the N-th function and adds the count of this function in S802. The system normalizes the probability in S803. The system may rank the functions in the second set based on the normalized probability in S804. The counting system moves forward one function in S805, and takes the next group of (N−1) functions and repeats the previous procedure.

After the system reads all of the codes it generates a table in which for each existed (N−1) function combination there are multiple N-th functions together with the counting score, or the normalized probability.

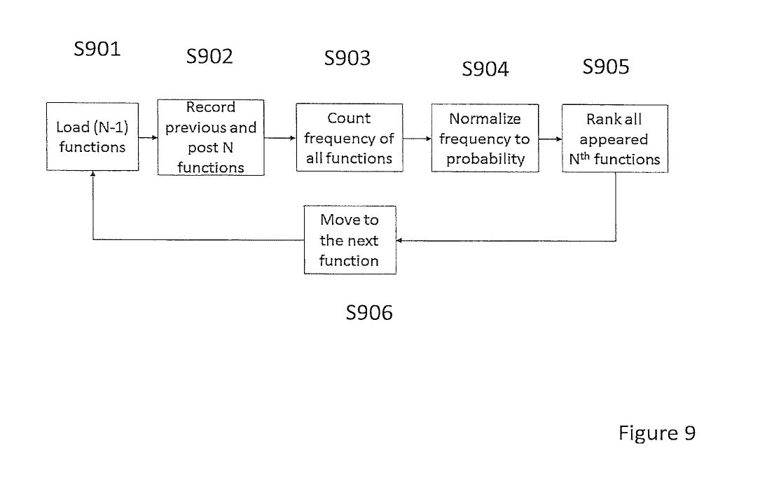

FIG. 9 shows a flow diagram of a method of automated code calculation in accordance with an embodiment. The method is based on the local correlation method.

For each input file, the system reads the functions from the beginning. The system reads (N−1) functions in S901 and sets this group of functions as the key (Row ID) in the database. Then the system records all of the previous and subsequent functions, in S902 and adds the counts corresponding to each of these functions in S903. The system normalizes the probability in S904 and may rank the functions in the second set based on the normalized probability in S905. After the counting the system moves forward one function in S906, and takes the next group of (N−1) functions and repeats the previous procedure.

After the system reads all of the codes it generates a table in which for each existed (N−1) function combination there are multiple N-th functions together with the counting score, or the normalized probability.

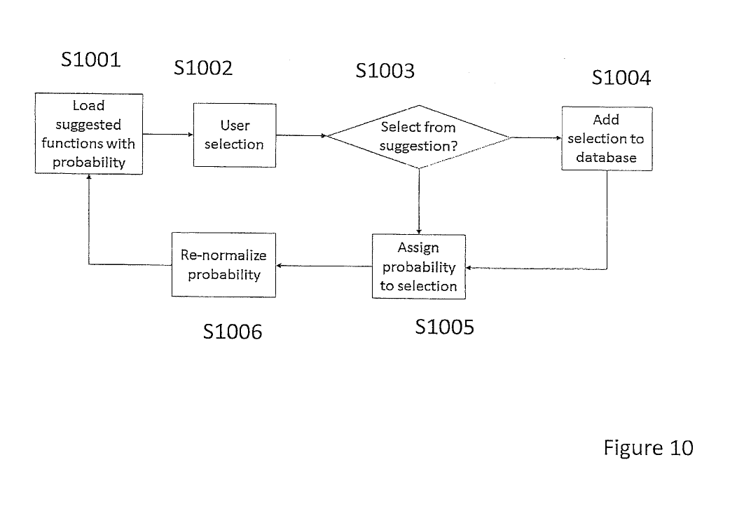

FIG. 10 shows a flow diagram of a method of automated code calculation in accordance with an embodiment.

After the user inputs the functions, the system searches the database for multiple suggested functions. The suggested functions may be ranked with probability in descending order and are outputted to the user in S1001. The user then either selects the function or functions suggested by the system or uses a new function(s) in S1002. S1003 determines whether the selection was contained in the suggestion. If it was contained in the suggestion, the system assigns a higher probability to the selected function in S1005 and updates the database by re-normalizing the probabilities in S1006. If it was not contained, the system adds the function to the database in S1004 and gives the new function a higher probability.

Further embodiments are set out in the following clauses:

A method of configuring an automated code calculation system, comprising:
retrieving information relating to a plurality of groups of functions;
converting each group to a multi-dimensional vector, wherein each dimension corresponds to a function;
storing the vectors.

2. The method according to clause 1, wherein converting a group to a vector comprises:
searching the information for a function corresponding to each function in a third set, wherein each function in the third set corresponds to a dimension;
updating a counting value corresponding to each dimension, wherein the counting value is higher if the function is contained in the group of functions than if the function is not contained in the group of functions.

3. The method according to clause 1, wherein the counting value is updated each time the corresponding function is found in the group, such that that counting value is higher the more times the function is contained in the group.

4. A method of automated code calculation, comprising:
retrieving information relating to a group of one or more functions;
converting the group to a multi-dimensional vector, wherein each dimension corresponds to a function;
storing the vector;
determining a difference measure between the vector and each stored vector;
outputting a list of one of more groups of functions and/or information of the location of code of one or more functions of the groups of functions corresponding to the one or more vectors with the lowest difference measure.

5. The method according to clause 4, wherein converting the item to a vector comprises:
searching the information for a function corresponding to each function in a third set, wherein each function in the third set corresponds to a dimension;
updating a counting value corresponding to each dimension, wherein the counting value is higher if the function is contained in the group of functions than if the function is not contained in the group of functions.

6. The method according to clause 4, wherein the counting value is updated each time the corresponding function is found in the group, such that that counting value is higher the more times the function is contained in the group.

7. The method according to any one of clauses 4 to 6, wherein the difference measure is a distance measure or a cosine similarity.

8. A system for automated code calculation, the system comprising: an input for receiving information relating to groups of one or more functions;
an output for outputting code information; and
a processor configured to:
   convert a group to a multi-dimensional vector, wherein each dimension corresponds to a function;
   store the vector;
   determine a difference measure between the vector and the stored vectors;
   output a list of one of more groups of functions corresponding to the one or more vectors with the lowest difference measure.

9. The system of clause 8, wherein the processor is further configured to:
perform tasks relating to control of an apparatus;
the system further comprising:
an apparatus output for outputting control signals to an apparatus.

10. An apparatus, controlled by the system of clause 9.

11. A carrier medium comprising computer readable code configured to cause a computer to perform the method of clause 1.

12. A carrier medium comprising computer readable code configured to cause a computer to perform the method of clause 4.

13. A method of automated code suggestion for a data flow programming language.

14. A method of automated code calculation and implementation for a data flow programming language.

While certain embodiments have been described, these embodiments have been presented by way of example only, and are not intended to limit the scope of the inventions. Indeed the novel methods and apparatus described herein may be embodied in a variety of other forms; furthermore, various omissions, substitutions and changes in the form of methods and apparatus described herein may be made without departing from the spirit of the inventions. The accompanying claims and their equivalents are intended to cover such forms of modifications as would fall within the scope and spirit of the inventions.

1. A method of configuring an automated code calculation system, comprising:
retrieving information relating to a group of two or more functions;
updating a weighting value for each combination of an item from a first set and an item from a second set, wherein each item in the first set and each item in the second set corresponds to one or more functions, wherein the weighting value is higher if the items are both contained in the group of functions than if one of the items is not contained in the group of functions;
storing the weighting values together with the corresponding combination of items.

2. The method of claim 1, wherein the information relating to the group of functions comprises the order of the functions in the group, and wherein the weighting value is higher if the item from the second set is the next item in the group after the item from the first set, than if it is not the next item in the group.

3. The method of claim 1, wherein the information relating to the group of functions comprises information relating to the creation time of the group of functions and wherein if the items are both contained in the group of functions, the weighting value is updated by a larger amount for a first group than for a second group where the creation time for the first group is more recent than for the second group.

4. The method of claim 3, wherein the weighting value is higher if the creation time is within a fixed time period.

5. The method of claim 1, wherein the group of functions is a node-based code.

6. A method of automated code calculation, comprising:
retrieving information relating to one or more functions;
searching for an item from a stored first set corresponding to the one or more functions, wherein each item in the first set corresponds to one or more functions;
outputting a list of the one or more items from a stored second set with a highest weighting value corresponding to the item from the first set, wherein each item in the second set corresponds to one or more functions.

7. The method of claim 6, wherein:
if the user selects an item from the second set, the weighting value for the combination of items corresponding to the item from the first set and the selected item from the second set is updated to a higher value.

8. The method of claim 6, wherein:
if the user selects an item which is not in the second set, adding the item to the second set and allocating a weighting value.

9. The method of claim 6, further comprising:
obtaining information identifying an item corresponding to one or more functions;
adding the item to the first set or the second set.

10. A system for automated code calculation, the system comprising: an input for receiving information relating to groups of one or more functions;
an output for outputting code information; and
a processor configured to:
update a weighting value for each combination of an item from a first set and an item from a second set, wherein each item in the first set and each item in the second set corresponds to one or more functions, wherein the weighting value is higher if the items are both contained in the group of functions than if one of the items is not contained in the group of functions;
storing the updated weighting values together with the corresponding combination of items;
search for an item from the first set corresponding to a group;
output a list of the one or more items from the second set with the highest weighting value corresponding to the item from the first set, wherein each item in the second set corresponds to one or more functions.

11. The system of claim 10, wherein the processor is further configured to:
perform tasks relating to control of an apparatus;
the system further comprising:
an apparatus output for outputting control signals to an apparatus.

12. An apparatus, controlled by the system of claim 11.

13. A carrier medium comprising computer readable code configured to cause a computer to perform the method of claim 1.

14. A carrier medium comprising computer readable code configured to cause a computer to perform the method of claim 6.
